(19) United States
(12) Patent Application Publication
(10) Pub. No.: US 2025/0013196 A1
(43) Pub. Date: Jan. 9, 2025

(54) POST-PROCESSING APPARATUS AND IMAGE FORMING SYSTEM

(71) Applicant: Takeshi HIRABAYASHI, KANAGAWA (JP)

(72) Inventor: Takeshi HIRABAYASHI, KANAGAWA (JP)

(21) Appl. No.: 18/762,701

(22) Filed: Jul. 3, 2024

(30) Foreign Application Priority Data
Jul. 7, 2023 (JP) 2023-112369

(51) Int. Cl. G03G 21/20; G03G 15/20

(52) U.S. Cl. CPC G03G 21/206; G03G 15/2017; G03G 15/2064; G03G 2215/00679; G03G 2215/00759; G03G 2215/00772

(57) ABSTRACT

A post-processing apparatus includes a post processer, a conveyor, a surface detector, an air blower, and a switch. The post processer performs post processing on a medium. The conveyor conveys the medium. The surface detector detects a surface of the medium. The air blower blows air toward the surface of the medium. The air blower includes an air blowing fan, multiple air blower ports, and an air duct. The air blowing fan generates airflow. The multiple air blower ports blow air to the medium. The air duct couples the air blowing fan and the multiple air blower ports to guide the air from the air blowing fan to each of the air blower ports. The switch controls the amount of the air blown from each of the multiple air blower ports to the medium based on a detection of the surface of the medium by the surface detector.

### CROSS-REFERENCE TO RELATED APPLICATIONS

This patent application is based on and claims priority pursuant to 35 U.S.C. § 119 (a) to Japanese Patent Application No. 2023-112369, filed on Jul. 7, 2023, in the Japan Patent Office, the entire disclosure of which is hereby incorporated by reference herein.

### BACKGROUND

### Technical Field

Embodiments of the present disclosure relate to a post-processing apparatus and an image forming system.

### Related Art

In an image forming apparatus employing an electrophotographic method, a medium (also referred to as, for example, a sheet of paper or a sheet material) is heated to fix an image on the medium. For this reason, the medium that has just been ejected from the image forming apparatus has a high temperature. When multiple media having a high temperature as described above are stacked, a phenomenon, i.e., blocking, in which melted toner on the media is solidified and the media are stuck, may occur.

To deal with such a phenomenon, an image forming apparatus is disclosed that includes a device to blow air taken in from outside onto an upper surface of a sheet material ejected onto an output tray to cool the sheet material. Such an image forming apparatus as described above blows air to the center of the upper surface of the ejected sheet material or the entire upper surface of the ejected sheet material radially via a sheet cooling duct.

In addition, a technology is also known that blows air to stacked media for a purpose other than preventing blocking, for example, to dry a sheet.

Such a technology has a configuration in which multiple blower fans are arranged in parallel to a direction in which sheets are stacked and the air volume of each of the blower fans is adjusted to efficiently perform seasoning of the stacked sheets.

### SUMMARY

In an embodiment of the present disclosure, a post-processing apparatus includes a post processer, a conveyor, a surface detector, an air blower, and a switch. The post processer performs post processing on a medium. The conveyor conveys the medium along a conveyance path in a conveyance direction. The surface detector detects a surface of the medium conveyed along the conveyance path. The air blower blows air toward the surface of the medium conveyed along the conveyance path. The air blower includes an air blowing fan, multiple air blower ports, and an air duct. The air blowing fan generates airflow. The multiple air blower ports face the conveyance path to blow air to the medium conveyed along the conveyance path. The air duct couples the air blowing fan and the multiple air blower ports to guide the air from the air blowing fan to each of the air blower ports. The switch controls the amount of the air blown from each of the multiple air blower ports to the medium based on a detection of the surface of the medium by the surface detector.

In another embodiment of the present disclosure, an image forming system includes an image forming apparatus to form an image on a medium and the post-processing apparatus disposed downstream from the image forming apparatus in the conveyance direction. The post-processing apparatus performs the post processing on the medium on which the image is formed by the image forming apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of an image forming system according to an embodiment of the present disclosure;

FIG. 2 is a diagram illustrating a post-processing apparatus and a part of an image forming apparatus according to an embodiment of the present disclosure;

FIG. 3 is a plan view of a relevant part of an air blower of the post-processing apparatus of FIG. 2, according to an embodiment of the present disclosure;

FIG. 4 is a side view of a relevant part of the blower of the post-processing apparatus of FIG. 3, according to an embodiment of the present disclosure;

FIGS. 5A and 5B are diagrams each illustrating a switch disposed in an air duct, according to an embodiment of the present disclosure;

FIG. 6 is a flowchart of a procedure of operations of the post-processing apparatus of FIG. 2, according to an embodiment of the present disclosure;

FIG. 7 is a block diagram of a functional configuration of the post-processing apparatus of FIG. 2, according to an embodiment of the present disclosure; and

FIG. 8 is a block diagram of a hardware configuration of a controller of the image forming system of FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description now is given of an image forming system and a post-processing apparatus according to an embodiment of the present disclosure, with reference to the drawings. Embodiments of the present disclosure are not limited to embodiments hereinafter described, and changes such as other embodiments, additions, modifications, and deletions may be made within the scope conceivable by those skilled in the art. Any aspects are included in the scope of the present disclosure as long as the actions and effects of the present disclosure are exhibited.

The terms “image formation”, “recording”, “text printing”, and “image printing” used herein may be used synonymously with each other.

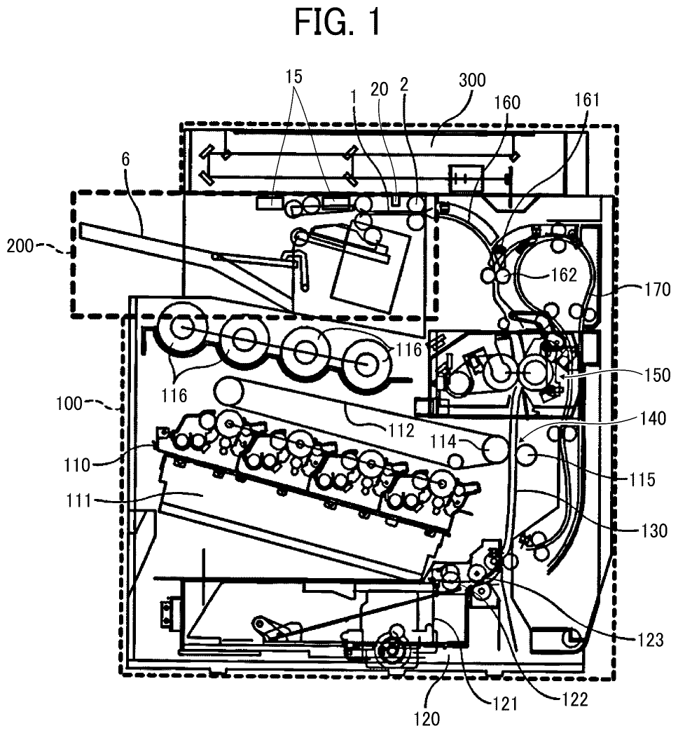

FIG. 1 is a schematic diagram illustrating a configuration of an image forming system according to an embodiment of the present disclosure.

The image forming system of the present embodiment includes an image forming apparatus 100 that forms an image on a medium, which may also be referred to simply as a sheet in the following description, and a post-processing apparatus 200. The post-processing apparatus 200 is disposed downstream from the image forming apparatus 100 and includes a post-processing device that performs post-processing on the medium.

The image forming apparatus 100 illustrated in FIG. 1 is a tandem-type color image forming apparatus employing an intermediate, i.e., indirect, transfer method.

The image forming apparatus 100 includes an image forming device 110, an optical writing device 111, a sheet feeder 120, a vertical conveyance path 130, a sheet ejection path 160, and a duplex conveyance path 170. The vertical conveyance path 130 serves as a sheet feeding path on which a sheet is conveyed to an intermediate transfer device 140 and a fixing device 150. The sheet ejection path 160 serves as a sheet feeding path on which a sheet with an image fixed on the sheet is conveyed to the post-processing apparatus 200. The duplex conveyance path 170 serves as a sheet reversing path on which a sheet with an image formed on one side of the sheet is reversed and an image is formed on the other side of the sheet. The image forming apparatus 100 also includes toner containers 116.

The image forming device 110 includes photoconductor drums for respective colors of yellow, magenta, cyan, and black (YMCK). A charging unit, a developing unit, a primary transfer unit, a cleaning unit, and a discharge unit are disposed around each of the photoconductor drums. The image forming apparatus 100 further includes an endless intermediate transfer belt 112 and optical writing units arranged in the optical writing device 111 to write an image on corresponding one of the photoconductor drums. Images that are formed on the photoconductor drums are transferred onto the intermediate transfer belt 112 by the primary transfer units.

The intermediate transfer belt 112 is rotatably supported by multiple support rollers. A support roller 114 that is one of the support rollers faces a secondary transfer roller 115 in an intermediate transfer device 140. The images on the intermediate transfer belt 112 are secondarily transferred to the sheet in the intermediate transfer device 140.

The sheet feeder 120 includes a sheet tray 121, a pickup roller 122, and a sheet feeding roller 123. The sheet that is fed from the sheet tray 121 is fed upward in the vertical conveyance path 130. The image is transferred to the sheet, which has been fed as described above, in the intermediate transfer device 140. Subsequently, the sheet is sent to the fixing device 150.

The fixing device 150 includes a fixing roller and a pressure roller to heat and press the sheet on which the image has been transferred to fix the image onto the sheet.

The sheet ejection path 160 on which the sheet is conveyed to the post-processing apparatus 200 and the duplex conveyance path 170 on which the sheet is conveyed to be subjected to duplex printing are disposed downstream from the fixing device 150 in the sheet conveyance direction. The sheet ejection path 160 and the duplex conveyance path 170 are branched by a separating claw 161. A conveyance roller pair 162 is disposed upstream from the separating claw 161 in the sheet conveyance direction.

The post-processing apparatus 200 is disposed in an in-body sheet ejection space of the image forming apparatus 100. The post-processing apparatus 200 performs predetermined post processing on the sheet conveyed from the image forming apparatus 100. The sheet or the sheet bundle that have been subjected to the post processing is ejected and stacked on an output tray 6. The sheet or the sheet bundle may be ejected without being subjected to the post processing.

The image forming apparatus 100 further includes an image reader 300 that optically scans a document set on an exposure glass to read an image on the surface of a document.

Image data is generated based on document data read from the image reader 300 or print data transmitted from an external apparatus such as a personal computer (PC) communicably connected to the image forming apparatus 100, and an image is formed based on the image data.

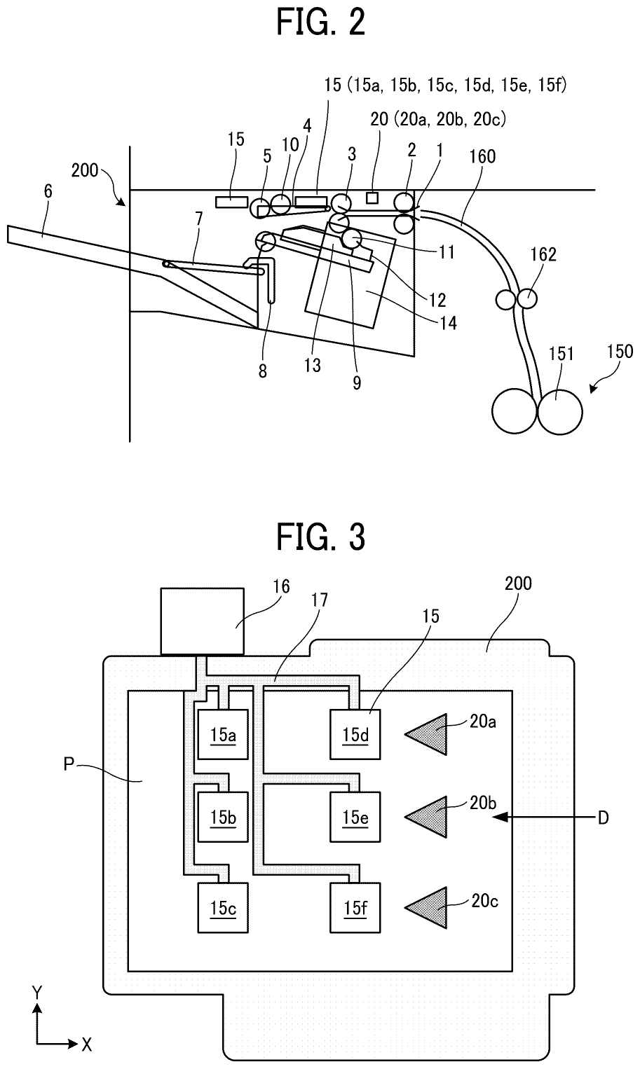

FIG. 2 is a diagram illustrating the post-processing apparatus 200 and a part of the image forming apparatus 100 according to the present embodiment.

The post-processing apparatus 200 of the present embodiment includes a conveyance path, a conveyor, surface detectors 20a, 20b, 20c, and a blower. The conveyance path guides a medium, i.e., a sheet, conveyed from the image forming apparatus 100 downstream in the sheet conveyance direction. The conveyor conveys the medium on the conveyance path. The surface detectors 20a, 20b, and 20c detects the surface of the medium on the conveyance path. The blower blows air toward the surface of the medium on the conveyance path.

As illustrated in FIG. 2, the post-processing apparatus 200 includes guide plates 1, an entrance roller pair 2, a post-processing sheet ejection roller pair 3, a sheet ejection opening-closing guide plate 4, a tapping roller 10, a sheet ejection roller 5, and the output tray 6. The guide plates 1, the entrance roller pair 2, the post-processing sheet ejection roller pair 3, the sheet ejection opening-closing guide plate 4, the tapping roller 10, the sheet ejection roller 5, and the output tray 6 are arranged in the conveyance path. The post-processing apparatus 200 also includes air blower ports 15a, 15b, 15c, 15d, 15e, and 15f as examples of blower ports of an air blower. The entrance roller pair 2 and the post-processing sheet ejection roller pair 3 that are disposed in the conveyance path function as conveyors of the sheet.

A lower driving roller of the entrance roller pair 2 and a lower driving roller of the post-processing sheet ejection roller pair 3 are each connected to a stepping motor via an endless belt. Accordingly, the entrance roller pair 2 and the post-processing paper ejection roller pair 3 rotate to convey the sheet in the conveyance path.

The sheet ejection roller 5 is connected to a sheet ejection motor via driving force transmitters such as a timing belt and a gear.

An entrance sensor that detects the sheet is disposed in the conveyance path. The entrance sensor detects the leading end and the trailing end of the sheet while the sheet is conveyed. The timing at which processing is performed on the sheet is determined by the timing at which the sheet is detected by the entrance sensor and the number of driving steps of the stepping motor and the sheet ejection motor.

When a straight sheet ejection is performed in which the sheet is ejected without being subjected to the post processing, the sheet that is conveyed from the image forming apparatus 100 to a space between each of the guide plates 1 is conveyed by the entrance roller pair 2 and the post-processing sheet ejection roller pair 3. Then, the sheet is further conveyed by the sheet ejection roller 5 with the sheet ejection opening-closing guide plate 4 closed and the sheet is ejected to the output tray 6.

The output tray 6 includes a movable member 7 upstream in the sheet conveyance direction. The movable member 7 is swingably supported by the output tray 6. An end of the movable member 7 upstream in the sheet conveyance direction is a free end, i.e., a pivot end. The movable member 7 is lowered when the number of ejected sheets reaches a predetermined number.

A sheet presser 8 that presses a sheet or a sheet bundle stacked on the output tray 6 is disposed close to a position at which an end of the output tray 6 is attached to the body of the post-processing apparatus 200. The sheet presser 8 presses and stops pressing in accordance with the conveyance of the sheet. When the trailing end of the sheet, i.e., the upstream end of the sheet in the sheet conveyance direction, passes through the post-processing sheet ejection roller pair 3, each of the post-processing sheet ejection roller pair 3 is retracted to a position at which each of the post-processing sheet ejection roller pair 3 does not interfere with the conveyance of the sheet.

The sheet presser 8 includes a sheet-surface sensor. When the sheet-surface sensor does not detect the surface of the sheet while the sheet presser 8 is at a position to press the sheet, the free end of the movable member 7 is lifted until the sheet-surface sensor detects the surface of the sheet. When the sheet-surface sensor detects the surface of the sheet, the free end of the movable member 7 is lowered until the sheet-surface sensor does not detect the surface of the sheet temporarily. Then, the free end of the movable member 7 is lifted until the sheet-surface sensor detects the surface of the sheet again. Such a configuration as described above allows the height of the free end of the movable member 7 in the output tray 6 on which sheets or a bundle of sheets are stacked to be maintained constant.

The post-processing apparatus 200 illustrated in FIG. 2 performs binding processing as an example of the post-processing. The post-processing apparatus 200 includes a staple tray 9 as a temporary sheet stacker, a trailing-end reference fence 12, jogger fences 13, and a stapler 14 as a post-processing device.

The binding process is a process of binding a predetermined number of sheets by the stapler 14 to form a sheet bundle and then ejecting the sheet bundle.

The tapping roller 10 that is driven in the vertical direction by a stepping motor is disposed between the post-processing sheet ejection roller pair 3 and the guide plate 1. The tapping roller 10 includes a lever part which moves up and down and a roller part. The roller part is driven to rotate in a direction opposite to the sheet conveyance direction.

When the post-processing is performed, the tapping roller 10 is lowered at a timing when the trailing end of the sheet passes through the post-processing sheet ejection roller pair 3, to press the sheet to a sheet loading surface of the staple tray 9 by the roller part of the tapping roller 10. Further, the roller part of the tapping roller 10 is rotated to switch back the sheet until the trailing end of the sheet contacts the trailing-end reference fence 12. In addition, switching back of the sheet is assisted by a return roller 11 disposed in the vicinity of the trailing-end reference fence 12, and the trailing end of the sheet contacts the trailing-end reference fence 12. By so doing, the sheet is aligned in the sheet conveyance direction.

Subsequently, the jogger fences 13 that are reciprocally movable in the sheet width direction as the aligning members align sheets in the sheet width direction.

When the alignment of the sheets is completed, each of the jogger fences 13 retracts to a position at which each of the jogger fences 13 does not contact lateral sides of the sheets in preparation for receiving next sheets. Subsequently, the jogger fences 13 repeat the operation to align sheets and the operation to retract as described above.

Rear ends of the sheets are inserted into a position at which the stapler 14 staples the sheets.

The binding processing is performed after the conveyance operation, the switchback operation, and the alignment operation of the designated number of sheets are completed.

After the binding processing is completed, the sheet ejection opening-closing guide plate 4 is closed, and the sheet bundle is ejected to the output tray 6 by the sheet ejection roller 5.

The sheets that are conveyed into the post-processing apparatus 200 are heated to a high temperature by the heating during the fixing processing in the image forming apparatus 100. When the sheets that are heated to the high temperature are stacked as they are, toner blocking of the sheets may occur due to melted toner on the sheets. In addition, when sheets to be post-processed are temporarily stacked in the post-processing apparatus 200, the heat of the sheets is confined in the post-processing apparatus 200. Accordingly, the ambient temperature in the vicinity of the post-processing apparatus 200 rises, and the temperature of the sheets also remains high. As a result, the toner blocking of the sheets is more likely to occur.

By contrast, the post-processing apparatus 200 of the present embodiment includes the air blower that blows air toward the surface of the sheet on the conveyance path and blows air without affecting the alignment of the stacked sheets. Accordingly, the post-processing apparatus 200 of the present embodiment can efficiently cool the sheets and prevent the toner blocking of stacked sheets.

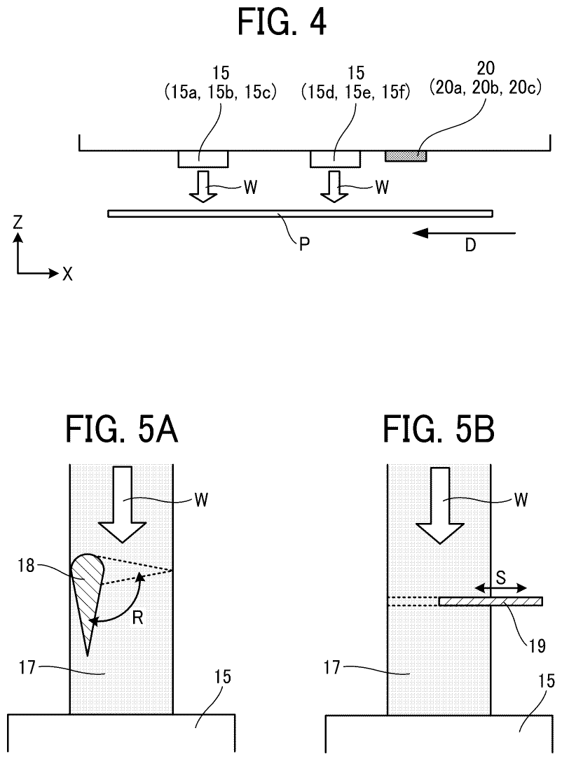

FIGS. 3 and 4 are diagrams each illustrating a schematic configuration of a relevant part of the air blower of the post-processing apparatus 200 of the present embodiment. FIG. 3 is a plan view of the relevant part of the air blower of the post-processing apparatus 200 viewed from above. FIG. 4 is a side view of the relevant part of the air blower.

The air blower includes an air blowing fan 16, multiple air blower ports 15 which are opened to face the surface of the sheet in the sheet conveyance path, and an air duct 17 which guides an air flow generated by the air blowing fan 16 to the air blower ports 15.

The post-processing apparatus 200 of the present embodiment includes surface detectors 20a, 20b, and 20c.

The controller controls to switch whether each of the air blower ports 15 blows air W (see FIG. 4) or not and/or controls the amount of air W blown from each of the air blower ports 15 based on the detection results of the surface detectors 20a, 20b, and 20c.

In FIG. 4, the sheet conveyance direction of a sheet P as a medium is indicated by arrow D. In FIG. 4, a direction in which air is blown from the air blower ports 15 is indicated by arrows W.

As illustrated in FIG. 4, air is blown from the air blower ports 15 in the direction indicated by arrows W toward the surface of the sheet P conveyed in the direction indicated by the arrow D.

In the example illustrated in FIG. 3, six air blower ports 15a, 15b, 15c, 15d, 15e, and 15f are arranged at regular intervals in directions indicated by arrow X and arrow Y.

The number of the air blower ports 15, the positions at which the air blower ports 15 are arranged, and the intervals between each of the air blower ports 15 is arranged from each other are not limited to the example illustrated in FIG. 3 and can be selected as needed.

In the example illustrated in FIG. 3, three surface detectors 20 (20a, 20b, 20c) are arranged at regular intervals in the Y direction.

For example, the air W that is blown from the air blower ports 15a, 15b, 15c, and 15d may be switched on or off based on the result detected by the surface detector 20a, the air W that is blown from the air blower ports 15b, 15c, 15d, and 15e may be switched on or off based on the result detected by the surface detector 20b, and the air W that is blown from the air blowers 15c, 15d, 15e, and 15f may be switched on or off based on the result detected by the surface detector 20c.

The number of the surface detectors 20, the positions at which the surface detectors are arranged, and the intervals between each of the surface detectors 20 is arranged from each other can also be selected as needed.

The air duct 17 includes switches to switch whether each of the air blower ports 15 communicating with the air duct 17 blows the air W or not and/or to control the amount of the air W blown from each of the air blower ports 15.

The post-processing apparatus 200 of the present embodiment includes a controller to control the air blower, and the controller controls the operation of the switches of the air duct 17 based on the detection results of the surface detectors 20a, 20b, and 20c.

FIGS. 5A and 5B are diagrams each illustrating a switch 18 and a switch 19, respectively, as an example of the switch in the air duct 17, according to an embodiment of the present disclosure.

FIG. 5A is a diagram illustrating the air duct 17 including the switch 18 that is pivotally rotated.

The switch 18 is pivotally rotated in directions indicated by double-headed arrow R in FIG. 5A. By so doing, the air W in the air duct 17 is restricted from flowing. When the switch 18 is at a position indicated by a broken line in FIG. 5A, the air W is blocked from flowing into the air blower port 15, downstream in the air W, that communicates with the air duct 17. Accordingly, the air blower port 15 does not blow the air W.

FIG. 5B is a diagram illustrating the air duct 17 including the switch 19 as a switch that is slidable in a direction perpendicular to a direction in which the air W flows.

The switch 19 moves in directions indicated by double-headed arrow S in FIG. 5B. Accordingly, the air W is restricted from flowing in the air duct 17. When the switch 19 is at a position indicated by a broken line in FIG. 5B, the air W is blocked from flowing into the air blower port 15, downstream in the airflow, that communicates with the air duct 17. Accordingly, the air blower port 15 does not blow the air W.

The surface detectors 20a, 20b, and 20c are, for example, sensors that detect the surface temperature of the medium, i.e., the sheet P, such as a sheet of paper.

The multiple surface detectors 20a, 20b, and 20c are arranged as illustrated in FIG. 3. By so doing, the temperatures of multiple areas of the sheet P can be detected.

Based on the detection results of the surface detectors 20a, 20b, and 20c, the controller identifies areas in which the surface temperature of the sheet P exceeds the reference value. Accordingly, the controller can control such that the air W is blown only from the air blower ports 15 facing the areas that exceed the reference value or the amount of air W blown from the air blower ports 15 facing the areas that exceed the reference value is increased.

The control of the amount of air blown from the air blower ports 15 includes control to change the amount of airflow generated by the air blowing fan 16.

The surface detectors 20a, 20b, and 20c are, for example, sensors that detect an image formed on the surface of the sheet P.

The multiple surface detectors 20a, 20b, and 20c are arranged as illustrated in FIG. 3. By so doing, the presence or absence of an image and the density of the image in multiple areas of the sheet P can be detected.

Based on the detection results of the surface detectors 20a, 20b, and 20c, the controller identifies areas in which an image is formed on the surface of the sheet P. Accordingly, the controller can perform control such that the air W is blown only from the air blower ports 15 facing the areas or the amount of air W blown from the air blower ports 15 facing the areas is increased.

The control of the amount of air W blown from the air blower ports 15 includes control to change the amount of airflow generated by the air blowing fan 16.

Such a configuration as described above can minimize the amount of air W blown to cool the medium, i.e., the sheet P. Accordingly, the influence of blown air W, which may cause the alignment of sheets P to be disturbed, can be reduced. At the same time, the noise when air W is blown can be reduced and the power consumption of the post-processing apparatus 200 can be reduced.

In addition, when the post-processing is performed, the controller performs control such that air W is not blown from the air blower ports 15 to areas in which the sheet bundle stacked on the staple tray 9 is affected. Thus, the accuracy of the sheet alignment can be prevented from being lowered.

It is preferable that the controller performs the control of the air blower based on data such as the ambient temperature in the vicinity of the image forming apparatus 100 and history data records of the sheets P heated in the image forming apparatus 100, in addition to the temperature data directly detected from the medium, i.e., the sheet P.

The post-processing apparatus 200 may further include a temperature acquisition unit that acquires a temperature at which the medium, i.e., the sheet P, is heated in the image forming apparatus 100. Accordingly, the controller can change the amount of air W blown from the air blower ports 15 in accordance with the temperature data acquired by the temperature acquisition unit. The temperature at which the medium is heated in the image forming apparatus 100 is, for example, the fixing temperature.

The post-processing apparatus 200 may further include a temperature acquisition unit that acquires the ambient temperature in the vicinity of the post-processing apparatus 200. Accordingly, the controller can change the volume of air W blown from the air blower ports 15 in accordance with the temperature data acquired by the temperature acquisition unit.

For example, the image forming system may include a sensor to detect the ambient temperature in the vicinity of the post-processing apparatus 200, and a sensor to detect the fixing temperature in the fixing device 150 of the image forming apparatus 100 in addition to the surface detectors 20a, 20b, and 20c. Accordingly, the controller can control such that the amount of air W blown from the air blower ports 15 is increased when the temperatures detected by the above-described sensors are higher than respective predetermined reference values.

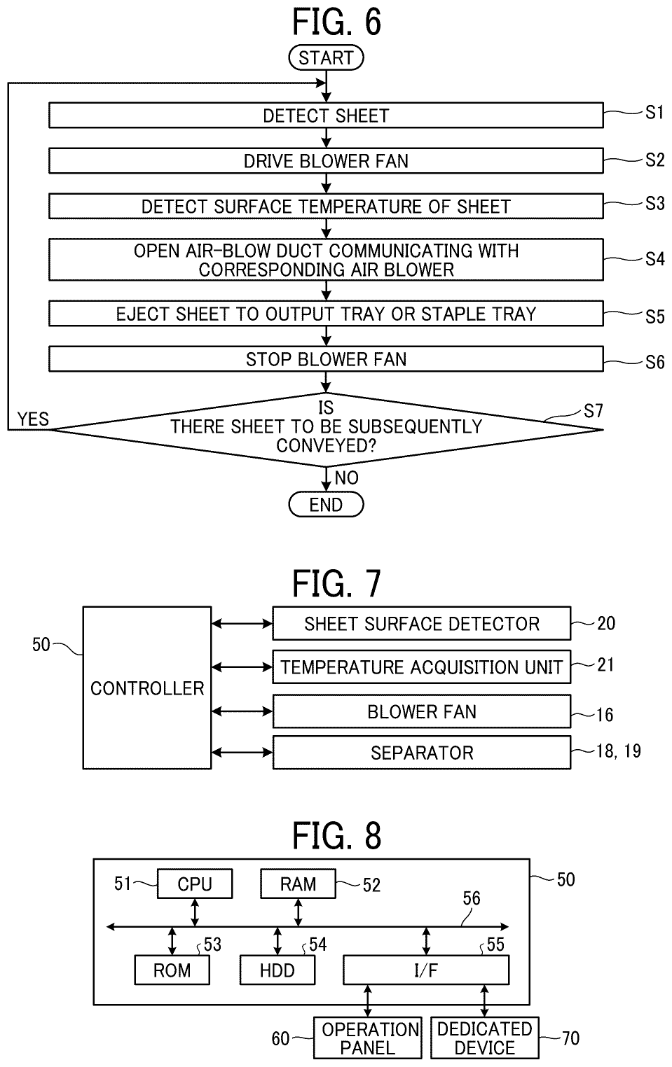

FIG. 6 is a flowchart of a procedure of operations in the post-processing apparatus 200, according to an embodiment of the present disclosure.

The sheet P on which an image is formed by the image forming apparatus 100 is conveyed in the sheet ejection path 160 and is conveyed into the post-processing apparatus 200.

After the sheet P is detected (step S1), the air blowing fan 16 of the air blower is driven (step S2).

The surface temperature of the sheet P conveyed in the conveyance path is detected by the surface detectors 20a, 20b, and 20c (step S3). When the detected surface temperature of an area of the sheet P exceeds the reference value, a portion of the air duct 17 that communicates with the air blower port 15 corresponding to the area is opened (step S4) to blow air W to the area of the sheet P.

The sheet P onto which the air W is blown in the conveyance path is ejected to the output tray 6 in the case of the straight sheet ejection and is ejected to the staple tray 9 when the post-processing is performed on the sheet P (step S5).

After the sheet P is ejected, the air blowing fan 16 is stopped (step S6).

The presence or absence of a sheet P to be subsequently conveyed is determined (step 7), and when the sheet P to be subsequently conveyed is present, the process returns to step S1, and the operations from step S1, S2, S3, S4, S5, S6, and S7 are repeated. When there is no sheet P to be subsequently conveyed, the operation is ended.

Performing such a control as described above can minimize the amount of the air W blown to the sheet P. Accordingly, the influence of the air W that affects the alignment of the sheets P can be reduced when the post-processing is performed. In addition, the air W can be efficiently blown to areas of the sheet P that needs to be cooled. Accordingly, toner blocking of the sheets P can be prevented. Further, the volume of the air W that is blown to the sheet P is minimized. Accordingly, noise reduction and energy saving can be achieved.

The functional configuration and the outline of the controller included in the post-processing apparatus 200 of the present embodiment is described with reference to FIGS. 7 and 8. The controller that serves as the controller of the post-processing apparatus 200 is connected to the controller of the image forming apparatus 100 via, for example, an interface (I/F), and the control of the post-processing apparatus 200 can be performed in response to processing signals from the image forming apparatus 100.

FIG. 7 is a block diagram of a functional configuration of the post-processing apparatus 200, according to an embodiment of the present disclosure.

As illustrated in FIG. 7, signals from the surface detectors 20a, 20b, 20c, and temperature acquisition units 21 are transmitted to a controller 50 of the post-processing apparatus 200. Examples of the temperature acquisition units 21 include a unit that detects the temperature of the ambient temperature in the vicinity of the post-processing apparatus 200 and a unit that detects the fixing temperature in the fixing device 150 of the image forming apparatus 100.

The controller 50 controls the driving of the air blower, i.e., the air blowing fan 16, and the switcher, i.e., the switch 18 or the switch 19 in response to signals from the surface detectors 20a, 20b, and 20c, and the various temperature acquisition units 21.

FIG. 8 is a block diagram of a hardware configuration of the controller 50 of the image forming apparatus 100, according to an embodiment of the present disclosure.

As illustrated in FIG. 8, the controller 50 includes a central processing unit (CPU) 51, a read only memory (ROM) 53, a random access memory (RAM) 52, a hard disk drive (HDD) 54, and an I/F 55.

The CPU 51 is an arithmetic device that executes a program stored in the ROM 53 to execute, for example, sequential, branching, and iterative processing and integrally controls the operation of the image forming apparatus 100. The ROM 53 is a nonvolatile storage device in which the program performed by the CPU 51 is stored. The RAM 52 is a memory that functions as a work area for the operation of the CPU 51.

The HDD 54 is a non-volatile storage medium capable of reading and writing data. A bus line 56 is an address bus or a date bus for electrically connecting the above-described components such as the CPU 51. An operation panel 60 and a dedicated device 70 are connected to the I/F 55. The I/F 55 connects the bus line 56 to, for example, various hardware and a network to control the hardware.

Each of the functions that are executed by the controller 50 according to the above-described embodiments can be implemented by one processing circuit or multiple processing circuits. In the embodiments of the present disclosure, the processing circuit includes a processor programmed to execute each of the functions by software such as a processor implemented by an electronic circuit, and a device such as an application specific integrated circuit (ASIC), a digital signal processor (DSP), a field programmable gate array (FPGA), or a conventional circuit module designed to execute each function described above.

Aspects of the present disclosure are, for example, as follows.

### First Aspect

A post-processing apparatus includes a post processor, a conveyor, a surface detector, an air blower, and a switch. The post processor performs post processing on a medium. The conveyor conveys the medium along a conveyance path in a conveyance direction. The surface detector detects a surface of the medium on the conveyance path. The air blower blows air toward the surface of the medium conveyed along the conveyance path. The air blower includes an air blowing fan, multiple air blower ports, an air duct. The air blowing fan generates airflow. The multiple air blower ports face the conveyance path to blow air to the medium conveyed along the conveyance path. The air duct couples the air blowing fan and the multiple air blower ports to guide the air from the air blowing fan to each of the air blower ports. The switch controls the amount of the air blown from each of the multiple air blower ports to the medium based on a detection of the surface of the medium by the surface detector. The post-processing apparatus is disposed downstream from an image forming apparatus in the conveyance direction.

### Second Aspect

The post-processing apparatus according to the first aspect, further includes a controller to control the air blower. The switch includes a valve in the air duct. The valve is openably closable to control the amount of the air blown from each of the air blower ports to the medium. The controller controls the valve based on the detection of the surface of the medium by the surface detector.

### Third Aspect

The post-processing apparatus according to the first or second aspect, further includes a controller to control the air blower. The surface detector detects a surface temperature of the medium to identify an area in the medium having the surface temperature exceeding a reference value. The controller controls the switch to blow the air to the area from the multiple air blower ports facing the area.

### Fourth Aspect

The post-processing apparatus according to any one of the first aspect to third aspect further includes a temperature acquisition unit to acquire a temperature of the medium heated before processed by the post-processing apparatus. The controller controls the air blower to change the amount of the air blown from the air blower to the medium based on the temperature acquired by the temperature acquisition unit.

### Fifth Aspect

The post-processing apparatus according to any one of the first aspect to fourth aspect, further includes a temperature acquisition unit to acquire an ambient temperature in the vicinity of the post-processing apparatus. The controller controls the air blower to change the amount of the air blown from the air blower to the medium based on the temperature acquired by the temperature acquisition unit.

### Sixth Aspect

The post-processing apparatus according to any one of the first to fifth aspect, further includes a controller to control the air blower. The surface detector detects an image formed on the surface of the medium. The controller identifies areas having the image in the medium detected by the surface detector and controls the switch to blow the air to the area from the multiple air blower ports facing the area.

### Seventh Aspect

An image forming system includes an image forming apparatus to form an image on a medium and the post-processing apparatus according to any one of the first to sixth aspects disposed downstream from the image forming apparatus in the conveyance direction. The post-processing apparatus performs the post-processing on the medium on which the image is formed by the image forming apparatus.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A post-processing apparatus comprising:
a post processer to perform post processing on a medium;
a conveyor to convey the medium along a conveyance path in a conveyance direction;
a surface detector to detect a surface of the medium conveyed along the conveyance path;
an air blower to blow air toward the surface of the medium conveyed along the conveyance path, the air blower including:
an air blowing fan to generate airflow;
multiple air blower ports facing the conveyance path to blow air to the medium conveyed along the conveyance path; and
an air duct coupling the air blowing fan and the multiple air blower ports to guide the air from the air blowing fan to each of the air blower ports; and
a switch to control an amount of the air blown from each of the multiple air blower ports to the medium based on a detection of the surface of the medium by the surface detector.

2. The post-processing apparatus according to claim 1, further comprising circuitry configured to control the air blower,
wherein the switch includes a valve in the air duct, the valve openably closable to control the amount of the air blown from each of the air blower ports to the medium, and
the circuitry controls the valve based on the detection of the surface of the medium by the surface detector.

3. The post-processing apparatus according to claim 1, further comprising circuitry configured to control the air blower,
wherein the surface detector detects a surface temperature of the medium to identify an area in the medium having the surface temperature exceeding a reference value, and
the circuitry controls the switch to blow the air to the area from the multiple air blower ports facing the area.

4. The post-processing apparatus according to claim 3, further comprising a temperature acquisition unit to acquire a temperature of the medium heated before processed by the post-processing apparatus,
wherein the circuitry controls the air blower to change the amount of the air blown from the air blower to the medium based on the temperature acquired by the temperature acquisition unit.

5. The post-processing apparatus according to claim 3, further comprising a temperature acquisition unit to acquire an ambient temperature in a vicinity of the post-processing apparatus,
wherein the circuitry controls the air blower to change the amount of the air blown from the air blower to the medium based on the temperature acquired by the temperature acquisition unit.

6. The post-processing apparatus according to claim 1, further comprising circuitry configured to control the air blower,
wherein the surface detector detects an image on the surface of the medium,
the circuitry is further configured to:
identify an area having the image in the medium detected by the surface detector; and
control the switch to blow the air to the area from the multiple air blower ports facing the area.

7. An image forming system comprising:
an image forming apparatus to form an image on a medium; and
the post-processing apparatus according to claim 1 disposed downstream from the image forming apparatus in the conveyance direction,
wherein the post-processing apparatus performs the post processing on the medium on which the image is formed by the image forming apparatus.
